(19) United States
(12) Patent Application Publication
(10) Pub. No.: US 2008/0108719 A1
(43) Pub. Date: May 8, 2008

(54) Phthalic Anhydride Based Polyester-Ether Polyols and Double Metal Cyanide Catalyst System for Preparing Same

(76) Inventors: Eric J. Geiger, Brookings, SD (US); Douglas K. Hillshafer, Western Springs, IL (US)

Correspondence Address: MCANDREWS HELD & MALLOY, LTD, 500 WEST MADISON STREET, SUITE 3400, CHICAGO, IL, 60661, US

(21) Appl. No.: 11/876,431

(22) Filed: Oct. 22, 2007

Related U.S. Application Data
(63) Continuation-in-part of application No. 11/000,675, filed on Nov. 30, 2004, now abandoned.
(63) Continuation of application No. 09/696,675, filed on Oct. 25, 2000, now Pat. No. 6,855,844.
(63) Continuation-in-part of application No. 09/427,050, filed on Oct. 25, 1999, now Pat. No. 6,569,352.

(51) Int. Cl. C08G 18/00

(52) U.S. Cl. 521/172; 528/85

(57) ABSTRACT

Disclosed are polyester-ether polyols and their use in urethane prepolymers, urethane foams and non-foam urethane coatings, adhesives, sealants and/or elastomers. Methods for producing such polyester-ether polyols using double metal cyanide catalysts are disclosed, along with methods for producing urethane prepolymers. The polyester-ether polyols of the instant invention are preferably the reaction product of phthalic anhydride, diethylene glycol, and propylene oxide. These polyester-ether polyols are useful as either the primary polyol in urethane compositions or in combination with conventional auxiliary polyester- and/or polyether-based polyols. The polyester-ether polyols impart greatly improved solubility and compatibility to mixtures of either polyether and/or polyester polyols. The polyester-ether polyols of the instant invention are desirably of lower viscosity than their precursor intermediate polyester polyols and are generally soluble in either polyester- and/or polyether-based polyols. Additionally, the polyester-ether polyols generally provide improved hydrolytic stability to CASE materials in which they are utilized.

### RELATED APPLICATIONS

This application is a continuation-in-part of U.S. patent application Ser. No. 11/000,675 filed Nov. 30, 2004; which is a continuation of U.S. patent application Ser. No. 09/696,675, filed Oct. 25, 2000 (issued as U.S. Pat. No. 6,855,844 on Feb. 15, 2005); which is a continuation-in-part application of U.S. patent application Ser. No. 09/427,050, filed Oct. 25, 1999 (issued as U.S. Pat. No. 6,569,352 on May 27, 2003).

All patent applications noted above are incorporated by reference in their entirety to provide for continuity of disclosure.

### BACKGROUND OF THE INVENTION

Disclosed are polyester-ether polyols and methods for producing such polyester-ether polyols employing a double metal cyanide catalyst, along with urethane prepolymers and methods for producing urethane prepolymers comprising the polyester-ether polyols. Such polyols and urethane prepolymers are useful in the preparation of urethane foams and/or non-foam urethanes, wherein the polyester-ether polyol is either the primary polyol component or is utilized in combination with conventional auxiliary polyester- and/or polyether-based polyols. The invention further relates to urethane foam and non-foam urethane compositions such as coatings, adhesives, sealants, and elastomers, which may be prepared utilizing the polyester-ether polyols and/or the urethane prepolymers derived therefrom. The polyols of the instant invention are preferably the reaction product of phthalic anhydride and diethylene glycol, to produce an intermediate polyester polyol, which is subsequently reacted with an alkylene oxide, e.g., propylene oxide, in the presence of a double metal cyanide catalyst, e.g., a zinc hexacyanometallate and in particular a zinc hexacyanocobaltate, to produce the subject polyester-ether polyols. These polyester-ether polyols impart greatly improved solubility and compatibility to or with mixtures of known alkylene oxide polyols (e.g., polypropylene oxide based polyether polyols) and polyester polyols. The polyester-ether polyols of the instant invention are desirably of lower viscosity than precursor polyester polyols and are generally soluble in either polyester- and/or polyether-based polyols.

Desirable physical properties of non-foam polyurethane coatings, adhesives, sealants and elastomers (CASE) include, among others, durability, flexibility, rigidity, hardness, toughness, resistance to abrasion, ability to bond to various substrates, and resistance to chemicals; one of the most desirable properties is hydrolytic stability. Coatings, adhesives, sealants and elastomers which are not resistant to hydrolysis undergo chain scission and gradual degradation of the other physical properties. Desirable properties of finished urethane foams include beneficial insulation characteristics and flame retardency. Industrial polyurethanes are generally made from the reaction of isocyanates/polyisocyanates and materials with multiple hydroxyl moieties (“polyols”). In many foam, adhesive and coatings formulations, polyols comprise the majority of the formulation weight, so that the final product properties are influenced mostly by the polyols.

Of the commercially available polyols, polyether- and polyester-containing materials are dominant. Polyether polyols are usually based on propylene oxide, ethylene oxide or tetrahydrofuran. These typically exhibit very good resistance to hydrolysis, which is an important requirement of many adhesives and coatings. However, polyether polyols promote adhesion to a very limited variety of substrates. In contrast, polyester polyols generally promote adhesion to more types of surfaces but are more susceptible to hydrolysis. Typically, a polyester molecule is hydrolyzed to an acid and alcohol as shown below. The hydrolysis may be acid or base catalyzed.

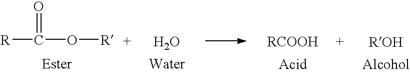

The deleterious consequence of such hydrolysis in a polyurethane material is the loss of desirable physical properties, as hydrolysis gives undesirable products with lower molecular weight.

In addition, polyester polyols are utilized in both foam and non-foam formulations to improve physical properties such as toughness, tensile and flexural strength, durometer hardness, solvent resistance, and thermal properties. Urethane coatings, and other applications, based on polypropylene oxide polyols and toluene diisocyanate have found limited applications, i.e. indoors only, as also they contain contaminant ether linkages which are readily prone to oxidative degradation. CASE materials derived from polyester polyols, such as those prepared by the condensation of an aliphatic dicarboxylic acids and poly alcohols, are widely used indoors and outdoors. Their primary function in finished CASE materials has been to enhance abrasion resistance. While these CASE materials possess better durability than those based on polypropylene oxide polyols and toluene diisocyanate, they also contain ether groups that undergo oxidative degradation.

Aliphatic polyester polyols, which contain ether linkages and/or ester linkages have found wide spread use in CASE, as additives which can provide improved bonding and durability. These materials are generally based on caprolactone or adipic acid backbones. One of the more widely used commercial polyester polyols is based on polycaprolactone and sold under the trade name Tone® (Union Carbide Corp.). This polyester polyol is the product of the homopolymerization of caprolactone with a hydroxyl containing compound as an initiator, such as a diol, to form polycaprolactone polyols. These polyester polyol materials are hydrolytically stable, resistant to yellowing, display excellent abrasion, chemical and impact resistance, they provide excellent resistance to oxidative degradation, and are considered to be the leaders of the commercial products which are currently available. However, such materials are generally of high molecular weight (i.e., 1000 g/mol), they are solids at about 25° C. which require heating (to about 60° C.) prior to use and they are therefore generally more difficult to formulate with as compared to lower melting, lower viscosity polyols.

Aliphatic polyester polyols based on adipic acid are prepared by the condensation of adipic acid and a diol, such as 1,6-hexanediol, as shown below:
HO₂C—(CH₂)₄—CO₂H+HO—(CH₂)₆—OH----->HO[—(CH₂)₆OOC—(CH₂)₄—COO—](CH2)₆—OH

These materials are well known to undergo hydrolytic degradation at the ester linkage cites of the molecule. However, the materials have the advantage of a low manufacturing cost, as compared to Tone® type materials, which is favorable from a consumer point of view.

Polyester polyols derived from phthalic anhydride (PA) and low molecular weight diols are reported in U.S. Pat. No. 4,644,027 to Magnus et al., issued Feb. 17 1987 and U.S. Pat. No. 4,644,047 to Wood, issued Feb. 17, 1987, for the production of cellular polyurethane and polyurethane/polyisocyanurates. Polyester polyols derived from PA and neopentyl glycol have been reported in U.S. Pat. No. 4,390,688 to Walz et al., issued Jun. 28, 1983. These materials are described as water dilutable polyesters with good resistance to xylene and dilute caustic solutions. PA polyester polyols have been used in polyurethane/polyisocyanurate rigid foams to impart low thermal conductivity, to lower cost and to lower blowing agent usage as reported in U.S. Pat. No. 4,791,148 to Riley et al., issued Dec. 13, 1988; U.S. Pat. No. 4,888,365 to Riley et al., issued Dec. 19, 1989 and U.S. Pat. No. 5,164,422 to Londrigan et al., issued Nov. 17, 1992. The PA based polyester polyols have been used in the preparation of urethane-modified isocyanurate foam as reported in U.S. Pat. No. 4,544,679 to Tideswell et al., issued Oct. 1, 1985.

Rigid foams have incorporated PA-based polyester polyols and perfluorinated hydrocarbons to enhance the thermal insulating properties of the foam, as reported in U.S. Pat. No. 4,981,879 to Snider, issued Jan. 1, 1991 and EP 394736 A2, Snider et al., Oct. 31, 1990. The preparation of urethane prepolymers utilizing conventional polyester and polyether polyols is disclosed in U.S. Pat. No. 5,021,507 to Stanley et al., issued Jun. 4, 1991, and more recently in U.S. Pat. No. 5,863,980 to Choi et al., issued Jan. 26, 1999.

From a preparation perspective, the use of double metal cyanide catalysts in the manufacture of various polyols is well-established in the art. For example, U.S. Pat. No. 3,829,505, assigned to General Tire & Rubber Company, discloses the preparation of high molecular weight diols, triols etc., using these catalysts. The polyols prepared using these catalysts can be fabricated to have a higher molecular weight and a lower amount of end group unsaturation than can be prepared using commonly-used KOH catalysts. The '505 patent discloses that these high molecular weight polyol products are useful in the preparation of nonionic surface active agents, lubricants and coolants, textile sizes, packaging films, as well as in the preparation of solid or flexible polyurethanes by reaction with polyisocyanates. For other double metal cyanide catalyst usage in the polyol context, see for example, U.S. Pat. Nos. 4,985,491 (to Olin Corp., issued Jan. 15, 1991); and 4,77,589 (to Shell Oil Company, issued Oct. 16, 1984).

The polymerization of epoxides such as propylene oxide or mixtures of propylene oxide and ethylene oxide using water and/or alcohols as initiators is also of great industrial importance since the resulting polyether alcohols or polyether polyols are very versatile compounds which can be used as such or as intermediates in the manufacture of various products such as (flexible) polyurethanes, detergents, oil additives and brake fluids.

The polymerization of epoxides is normally carried out under basic conditions, i.e. by using potassium hydroxide or sodium hydroxide as a catalyst. Although products (polyether polyols or polyether alcohols) of good quality can be obtained, the use of these inorganic bases limits the capacity of the process since a long batch time is required to warrant good quality products. Shortening the batch times is not readily achievable by simply using more catalyst, as such increased usage would impose an unacceptable and significant increase in monetary costs. Shortening of the batch time is not however impossible, but it has the intrinsic disadvantage that the selectivity of the process is decreased substantially, which seriously affects the product properties.

Therefore, alternative catalytic systems allowing in principle a shorter batch time have already been proposed in the art. Reference is made in this respect to double metal cyanide complexes such as are disclosed in British Patent Specification No. 1,149,726 (for instance zinc hexacyanometallate complexes also containing zinc chloride, water and an organic ligand) and in East German Patent Specification No. 148,957 (specifically metal hexacyano-iridium complexes also containing zinc chloride, water and an ether).

As mentioned above, both polyester-based and polyether-based polyols have their respective beneficial properties and drawbacks/limitations. Additionally, and perhaps most importantly, polyether and polyester polyols are generally not compatible with each other, i.e., they are often not readily soluble or miscible, and therefore are not readily capable of being employed as a mixture for use in any particular application. An ideal polyol would have the desirable properties exhibited by both ester- and ether-based polyols, with limited disadvantages of each previously mentioned. Additionally, and most importantly, there has been a long felt need for a polyol which can function as either a primary polyol or co-polyol in urethane and urethane prepolymer applications and/or compatibilize, i.e. solubilize, reduce viscosity, and make miscible, mixtures of conventional polyester and polyether polyols.

### BRIEF SUMMARY OF THE INVENTION

This invention relates to novel polyester-ether polyols and their use in preparing urethane prepolymers. Additionally, the invention relates to the use of such polyols and prepolymers in making urethane foams and non-foam urethane coatings, adhesives, sealants and/or elastomers. Methods for producing the polyester-ether polyols are disclosed using double metal cyanide complexes, along with methods for producing urethane prepolymers. It has been surprisingly discovered that the polyester-ether polyols of the instant invention possess highly desirable properties, such as reduced viscosity, improved ease of handling and are highly compatible with ester- and/or ether-based conventional polyols, i.e. they are generally soluble/miscible in either polyester- and/or polyether-based polyols.

The polyester-ether polyols are useful as either the primary polyols in urethane prepolymers, urethane foams and non-foam urethanes, or as a co-polyol in combination with auxiliary conventional ether- and/or ester-based polyols. Additionally, the polyester-ether polyols generally provide improved hydrolytic stability to CASE materials in which they are utilized.

It has been surprisingly discovered that the inventive polyester-ether polyols are soluble in and are compatible with other phthalic and/or, non-phthalic anhydride based polyester polyols of similar molecular weights, such as caprolactone based polyester polyols, adipic acid based polyester polyols, terephthalate based polyester polyols, isophthalate based polyester polyols, and other aliphatic based polyester polyols. The polyester-ether polyols of the instant invention provide a unique combination of improved low viscosity and compatibility/compatibilization of polyester and polyether based polyols, which allows for the utilization of the conventional ether- and ester-based polyols in combination with each other. The polyester-ether polyols of the instant invention allow for the formation of stable and compatibilized mixtures of ester- and ether-based polyols which are usually immiscible.

### BRIEF DESCRIPTION OF SEVERAL VIEWS OF THE DRAWINGS

[Not Applicable]

### DETAILED DESCRIPTION OF THE INVENTION

The polyester-ether polyols of the present invention are generally the reaction product of phthalic anhydride (PA), a polyhydroxyl compound, and an alkoxylating agent, e.g., propylene oxide, as shown below: 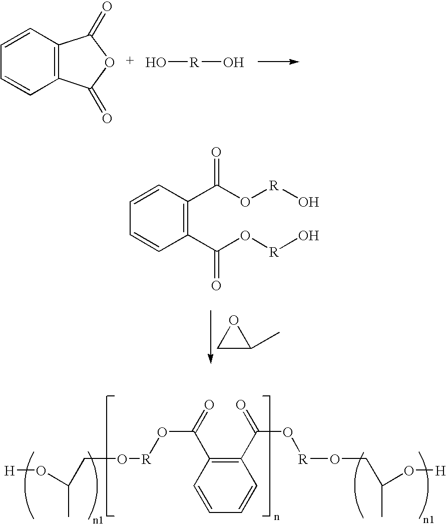
wherein R is branched or linear, saturated or unsaturated C2-10 alkyl, cycloalkyl, alkenyl, alkynl, aromatic, polyoxyethylenic, polyoxypropylenic; wherein R may contain pendant secondary functionality such as hydroxyl, aldehyde, ketone, ether, ester, amide, nitrile, amine, nitro, thiol, sulfonate, sulfate, and/or carboxylic groups; n is typically 1-200 and each n1 is independently 1-200. Where pendant secondary hydroxyl functionality is present, such hydroxyl groups may optionally be alkoxylated. Preferably, phthalic anhydride is reacted with a polyol, i.e., a diol such as diethylene glycol to form an intermediate polyester polyol.

The intermediate polyester polyol is then reacted with an alkoxylating agent, such as propylene oxide, to form the polyester-ether polyol. Although traditional catalysts, such as sodium hydroxide have proven useful to effectuate the alkoxylation, it has been surprisingly discovered that the alkoxylation reaction can be more efficiently conducted using a double metal cyanide catalyst, especially when the alkoxylating agent is propylene oxide. Without wishing to be bound by any particular theory, it is speculated that unsaturated end groups result in monofunctional species that act as chain stoppers/terminators in elastomer/polymer formation, whereby such formation is highly undesirable. In typical polyol synthesis with KOH catalysis the unsaturation formed increases as a direct function of equivalent weight. Eventually conditions are established wherein further alkylene oxide, e.g., propylene oxide, addition fails to increase the molecular weight. In other words the use of alkali catalysts to produce high molecular weight, hydroxy terminated polyoxypropylene ethers typically results in a substantial loss in hydroxy functionality. It has been discovered that with double metal cyanide catalysis much less unsaturation is formed allowing higher equivalent weight polyester ether polyols to be prepared.

Further, although the difference between the molecular structures of ethylene oxide (EO) and propylene oxide (PO) appear to be small, it is known that EO and PO behave very differently during alkoxylation reactions even when the same catalyst is used, and the two reactions are not comparable. For example, when a KOH catalyst is used to alkoxylate a polyester polyol, saponification is a competing side-reaction to the alkoxylation reaction. However, because ethoxylation proceeds much more rapidly than propoxylation using KOH catalyst, saponification is not a significant problem when EO is used. Under identical reaction conditions, however, saponification is a serious problem for propoxylation of polyester polyols. Unexpectedly, use of a double metal cyanide catalyst can successfully catalyze the propoxylation reaction of polyester polyols and substantially avoid the saponification problem caused by a base catalyst (e.g., KOH) for the propoxylation of such polyester polyols. Such a result was unexpected because oxyalkylation of hydric initiators with DMC complex catalysts has been found to be inefficient in the presence of low molecular weight, polyols, e.g., polyols having a molecular weight of about 400 or less. Therefore, those of skill in the art have generally concluded that low molecular weight polyols are unacceptable for use in DMC catalyzed alkoxylation reactions. See, e.g., Polyols Derived from Double Metal Cyanide Catalysts, UTECH 2000; U.S. Pat. No. 5,679,764; U.S. Pat. No. 5,773,525; U.S. Pat. No. 6,835,801; and U.S. Pat. No. 6,359,101.

The double metal cyanide complex class catalysts suitable for use herein and their preparation are described in U.S. Pat. Nos. 4,472,560 and 4,477,589 to Shell Chemical Company and U.S. Pat. Nos. 3,941,849 and 4,335,188 to General Tire & Rubber Company. The teachings of the foregoing patents are incorporated herein by reference.

One class of double metal cyanide complex catalysts found particularly suitable for use herein is are zinc hexacyanometallates of the general formula:
Zn₃[M(CN)₆]₂.xZnCl₂.yGLYME.zH₂O
wherein M may be Co(III), or Cr(III) or Fe(II) or Fe(III); x, y, and z may be fractional numbers, integers, or zero and vary depending on the exact method of preparation of the complex. Also useful is a zinc hexacyanometallates of the general formula:
Zn₂[M(CN)₆].xHCl.yGLYME.zH₂O
wherein M is defined as above.

A highly preferred double metal cyanide complex catalyst found particularly suitable for use is a zinc hexacyanometallate of formula:
Zn₂[Co(CN)₆]Cl-0.5HCl-DME-2.75H₂O
as described in J. Catal (105) 163-174, 1987 by Kuyper and Boxhoorn, including its preparation, incorporated herein by reference in its entirety.

Other suitable catalysts include general formula:
Mₐ¹[M²(CN)_{b}(A)_{c}]_{d}.wM³Dₑ.xH₂O.yL.zHₙEₘ
wherein M1 represents at least one of Zn(II), Fe(II), Co(II), Ni(II), Mn(II), Cu(II), Sn(II) or Pb(II); M2 represents at least one of Fe(II), Fe(III), Co(III), Cr(III), Mn(III), Mn(III), Ir(III), Rh(III), Ru(II), V(IV) or V(V); M3 represents M1 and/or M2; A, D and E each represent an anion which may be the same or different; L represents an alcohol, aldehyde, acetone, ether, ester, amide, nitrile or sulphide or mixtures thereof; a and d are numbers to satisfy the valency state of M1 and M2 in the double metal cyanide part of the general formula I; b and c are integers (b>c) which together with a and d provide the electroneutrality of the double metal cyanide part of the general formula I; e is an integer satisfying the valency state of M3; n and m are integers satisfying the electroneutrality of HE, and w is a number between 0.1 and 4; x is a number up to 20; y is a number between 0.1 and 6, and z is a number between 0.1 and 5.

Other useful catalysts include zinc hexacyano cobaltates according to the general formula:
Zn₃[Co(CN)₆]₂.wM³X₂.xH₂O.yL.zHX
wherein X represents a halide; M3 represents Zn(II), Co(II) or Fe(II); L represents an alcohol, ether or ester and w is a number between 0.7 and 1.5; x is a number between 2 and 10; y is a number between 1.5 and 3, and z is a number between 0.15 and 1.5.

In accordance with this formula and the above formula, L can be an alcohol, aldehyde, ketone, ether, ester, amide, nitrile or sulphide. Examples of alcohols include lower alcohols such as methanol, ethanol, propanol, isopropanol and butanol. Higher alcohols as well as alcohols containing aromatic rings can also be used. Examples of aldehydes include formaldehyde, acetaldehyde, butyraldehyde, pivalaldehyde, glyoxal, benzaldehyde and cinnamic aldehyde. Examples of ketones include acetone, methyl ethyl ketone, methyl isobutyl ketone, diethyl ketone and cyclohexanone. Examples of ethers include monoethers, diethers and polyethers as well as cyclic ethers such as dimethyl ether, diethyl ether, dibutyl ether, methyl t-butyl ether, bis-(beta-methoxy ethyl)ether, ethylene glycol dimethyl ether, triethylene glycol dimethyl ether, dimethoxy methane, diethoxy methane, acetal, trimethylol propane trimethyl ether, dioxane, trioxyethylene and paraldehyde. Preference is given to the use of acyclic ethers, in particular acyclic diethers such as dimethoxy ethane (ethylene glycol dimethyl ether). Also hydroxy ethers such as ethylene glycol monomethyl ether and related compounds can be used conveniently. Examples of esters include methyl formate, ethyl formate isopropyl formate, methyl acetate, ethyl acetate, propyl acetate, ethylene glycol diacetate and triethylene glycol diacetate. Examples of amides include formamide, acetamide, propionamide, valeramide as well as urea and derivatives thereof. Examples of nitriles include acetonitrile, propionitrile and valeronitrile. Examples of sulphides include dimethyl sulphide, diethyl sulphide and ethyl butyl sulphide. Also mixtures of two or more organic compounds can be applied.

The acids according to the general formula HₙEₘ which are present in the double metal cyanides comprise hydrochloric acid, hydrobromic acid, hydroiodic acid, nitric acid, sulphuric acid, phosphoric acid, (per)chloric acid, carboxylic acids such as acetic acid and benzoic acid, halogen-substituted carboxylic acids such as trichloro acetic acid and trifluoro acetic acid, alkyl sulphonic acids and aryl sulphonic acids such as methane sulphonic acid and para-toluene sulphonic acid. Preference is given to the hydrogen halides and sulphuric acid, and particularly hydrogen chloride and hydrogen bromide. Mixtures of acids can also be used suitably.

The present invention relates to a process for the preparation of polyester-ether polyols which comprises alkoxylating at least one polyester polyol compound in the presence of at least one alkoxylating agent, in the presence of at least one double metal cyanide complex catalyst as disclosed above. The present invention further relates to the polyester-ether polyols produced by the above process.

While a wide variety of polyhydridic alcohols may be utilized in the present invention to prepare the intermediate polyester polyols, preferred PA polyester polyol intermediates are of the form 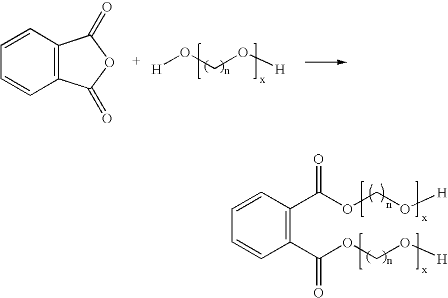
wherein n=2-10, x=1-500. Highly preferred PA polyester polyol intermediates for use in the present invention are derived from the condensation of phthalic anhydride and ethylene glycol, diethylene glycol, propylene glycol, dipropylene glycol, neopentyl glycol, 1,4-butanediol, 1,6-hexanediol, polyethylene glycol, polypropylene glycol triethylene glycol, and tetramethylene glycol and mixtures thereof.

Alkoxylating agents useful herein include any agent capable of providing a sufficient amount of ether moieties to the final polyester-ether polyol. Preferred alkoxylating agents are ethylene oxide, propylene oxide, butylene oxide, or mixtures thereof.

The phthalic anhydride based polyester-ether polyols are compatible with standard foam flowing and formation techniques and are also compatible with atmospheric curing, heat curing, and exhibit normal pigmentation compatibility.

The invention encompasses polyester-ether polyols, methods for preparing such polyols, and their use in preparing urethane prepolymers, urethane foams and non-foam urethane coatings, adhesives, sealants and/or elastomers. The polyester-ether polyols of the instant invention are preferably the reaction product of phthalic anhydride and/or phthalic acid, a diol, and an alkoxylating agent, wherein the phthalic anhydride and/or phthalic acid and the diol are first reacted to form an intermediate polyester polyol, which is subsequently reacted with an alkoxylating agent (e.g., propylene oxide), to give a polyester-ether polyol. Although the polyester-ether polyols of the instant invention are useful as the primary polyols in the preparation of urethane prepolymers, urethane foams and CASE materials, they are primarily and preferably useful as compatibilizing polyols in combination with polyester and/or polyether polyols.

Accordingly, the instant invention encompasses a composition suitable for preparing urethane prepolymers and/or urethane foams or non-foam urethane coatings, adhesives, sealants and/or elastomers, comprising:

(a) from 0% to about 5.0% based on the weight of the composition of a urethane catalyst;

(b) from about 23% to about 55% based on the weight of the composition of a phthalate polyester-ether polyol which is the reaction product of:
(1) about 42% to about 52% based on the weight of the polyester-ether polyol of phthalic anhydride or phthalic acid; and
(2) about 33% to about 58% based on the weight of the polyester-ether polyol of at least one polyol of the formula:
   HO—R₁—OH
wherein R₁ represents:
   (a) alkylene groups of about 2 to about 10 carbon atoms;
   (b) —CH₂—R₂—CH₂— 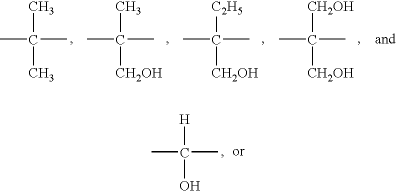
   where R₂ represents:
   (c) —(R₃O)ₙ₂—R₃—
   where each R₃ independently is an alkylene group of about 2 to about 4 carbon atoms, and n2 is an integer of from about 1-200; and
(3) about 45% to about 77% based on the weight of the polyester-ether polyol of an alkoxylating agent;

(c) from 0% to about 50% by weight of an auxiliary polyether polyol, polyester polyol, or a mixture thereof;

(d) from 0% to about 10% based on the weight of the composition of a blowing agent; and

(e) from 0% to about 5% based on the weight of the composition of a compatibilizing surfactant.

The R₁ alkylene groups may be branched or straight chain, saturated or unsaturated, and when R₂ contains a hydroxyl moiety, such hydroxyl group may be optionally alkoxylated. The polyester-ether polyol is preferably the reaction product of phthalic anhydride or phthalic acid, the polyol, and the alkoxylating agent, wherein the phthalic anhydride or phthalic acid and the polyol are first reacted to from an intermediate polyester polyol, which is subsequently reacted with the alkoxylating agent to give the polyester-ether polyol.

The instant invention further encompasses a composition suitable for preparing urethane prepolymers and/or urethane foams or non-foam urethane coatings, adhesives, sealants and/or elastomers, comprising:

(a) from about 10% to about 60% based on the weight of the composition of an isocyanate;

(b) from about 23% to about 55% based on the weight of the composition of a phthalate polyester-ether polyol which is the reaction product of:
(1) about 42% to about 52% based on the weight of the polyester-ether polyol of phthalic anhydride or phthalic acid; and
(2) about 33% to about 58% based on the weight of the polyester-ether polyol of at least one polyol of the formula:
   HO—R₁—OH
wherein R₁ represents:
   (a) alkylene groups of about 2 to about 10 carbon atoms;
   (b) —CH₂—R₂—CH₂—
   where R₂ represents: 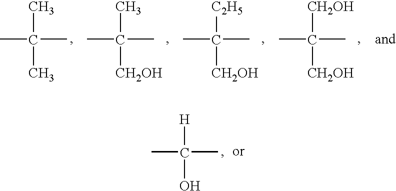
   (c) —(R₃O)ₙ₂—R₃—
   where each R₃ independently is an alkylene group of about 2 to about 4 carbon atoms, and n2 is an integer of from about 1-200; and
(3) about 45% to about 77% based on the weight of the polyester-ether polyol of an alkoxylating agent.

(c) from 0% to about 50% based on the weight of the composition of an auxiliary polyether polyol, polyester polyol, or a mixture thereof;

(d) from 0% to about 10% based on the weight of the composition of a blowing agent; and

(e) from 0% to about 5% based on the weight of the composition of a compatibilizing surfactant.

The R alkylene groups may be branched or straight chain, saturated or unsaturated, and when R₂ contains a hydroxyl moiety, such hydroxyl group may be optionally alkoxylated. The polyester-ether polyol is preferably the reaction product of phthalic anhydride or phthalic acid, the polyol, and the alkoxylating agent, wherein the phthalic anhydride or phthalic acid and the polyol are first reacted to from an intermediate polyester polyol, which is subsequently reacted with the alkoxylating agent to give the polyester-ether polyol.

Most commonly when a urethane prepolymer is desired, it is prepared by condensation polymerization, i.e., the isocyanate with the polyol(s), most preferably the polymerization of a diisocyanate with a diol. A prepolymer is generally defined as a non-stoichiometric reaction product of an isocyanate and a polyol. The urethane prepolymers may also be prepared by polymerizing the compositions disclosed herein in the presence of an optional polyamino or a polymercapto-containing compound such as diamino polypropylene glycol or diamino polyethylene glycol or polythioethers such as the condensation products of thiodiglycol either alone or in combination with other glycols such as ethylene glycol, 1,2-propylene glycol or with other polyhydroxy compounds disclosed herein. Also, small amounts of low molecular weight dihydroxy, diamino, or amino hydroxy compounds may be used such as saturated and unsaturated glycols e.g. ethylene glycol or condensates thereof such as diethylene glycol, triethylene glycol, and the like; ethylene diamine, hexamethylene diamine and the like; ethanolamine, propanolamine, N-methyldiethanolamine and the like. Typically for the preparation of urethane prepolymers, the isocyanate, polyol(s), and other components are combined in proportions so as to yield a urethane prepolymer characterized by an isocyanate content of from about 0.25 to about 25%, preferably to about 1 to 10%, and most preferably from about 1.5% to about 5%. In addition, the ratio of isocyanate equivalents to hydroxyl, amino or mercapto equivalents (known as the isocyanate index) should be greater than 1 but no more than about 2 for prepolymer preparation. The precise amount of the isocyanate used in the polymerization will depend on the equivalent weight and amount of the non-isocyanate components, and the particular isocyanate employed. In general, the amount of the isocyanate needed to achieve the isocyanate content will vary from about 5 to about 55% of the final prepolymer.

The invention further encompasses a composition suitable for preparing urethane prepolymers and/or urethane foams or non-foam urethane coatings, adhesives, sealants and/or elastomers, comprising:

(a) from about 10% to about 70% based on the weight of the composition of an isocyanate;

(b) from about 0.02% to about 5.0% based on the weight of the composition of a urethane catalyst; and

(c) from about 23% to about 90% based on the weight of the composition of a phthalate polyester-ether polyol which is the reaction product of:
(1) about 42% to about 52% based on the weight of the polyester-ether polyol of phthalic anhydride or phthalic acid; and
(2) about 33% to about 58% based on the weight of the polyester-ether polyol of at least one polyol of the formula:
   HO—R₁—OH
   wherein R₁ represents:
   (a) alkylene groups of about 2 to about 10 carbon atoms;
   (b) —CH₂—R₂—CH₂—
   where R₂ represents: 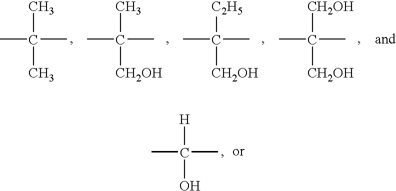
   (c) —(R₃O)ₙ₂—R₃—
   where each R₃ independently is an alkylene group of about 2 to about 4 carbon atoms, and n2 is an integer of from about 1-200; and
(3) about 45% to about 77% based on the weight of the polyester-ether polyol of an alkoxylating agent selected from the group consisting essentially of ethylene oxide, propylene oxide or butylene oxide or mixtures thereof;

(d) from 0% to about 50% based on the weight of the composition of an auxiliary polyether polyol, polyester polyol, or a mixture thereof.

(e) from 0% to about 10% based on the weight of the composition of a blowing agent; and

(f) from 0% to about 5% based on the weight of the composition of a compatibilizing surfactant.

The R₁ alkylene groups may be branched or straight chain, saturated or unsaturated, and when R₂ contains a hydroxyl moiety, such hydroxyl group may be optionally alkoxylated. The polyester-ether polyol is preferably the reaction product of phthalic anhydride or phthalic acid, the polyol, and the alkoxylating agent, wherein the phthalic anhydride or phthalic acid and the polyol are first reacted to from an intermediate polyester polyol, which is subsequently reacted with the alkoxylating agent to give the polyester-ether polyol.

In a more preferred embodiment the compositions suitable for preparing urethane prepolymer and/or urethane foams and non-foam urethane coatings, adhesives, sealants and/or elastomers will comprise from about 10% to about 40%, most preferably from about 10% to about 30% of the isocyanate when present; from about 0.5% to about 4.0%, most preferably from about 0.5% to about 3.0% of the urethane catalyst when present; from about 23% to about 55%, most preferably from about 41% to about 55% of the phthalate polyester-ether polyol, wherein the phthalate polyester-ether polyol preferably comprises from about 42% to about 52% of phthalic acid and/or phthalic anhydride; preferably from about 33% to about 58% of the polyol; and preferably from about 45% to about 77% of the alkoxylating agent. In highly preferred embodiments, the alkoxylating agent is propylene oxide and is present in about 50% to about 65% by weight, based on the intermediate polyester polyol. In a more preferred embodiment the urethane prepolymers and/or urethane compositions will comprise from about from about 5% to about 40%, most preferably from about 10% to about 30% of the auxiliary polyether polyol, polyester polyol, or a mixture thereof.

The compositions disclosed herein may be substantially free of CFC and/or hydrocarbon blowing agents (i.e. they contain less than 1% by weight of a blowing agent) and are suited for use in non-foam applications, i.e., CASE. Alternatively, the compositions of the present invention may optionally contain CFC and/or hydrocarbon blowing agents and be suited for use in foam applications, i.e., open and closed cell foams. Optionally, the composition disclosed herein may additionally contain from about 0.01% to about 20.0% by weight of a polyisocyanurate.

In a preferred embodiment, the alkoxylating agent is propylene oxide. Highly preferred isocyanates are 2,4- and/or 2,4/2,6-toluene diisocyanate, diphenyl methane 4,4′-diisocyanate, hexamethylene diisocyanate, isophorone diisocyanate, or mixtures thereof. Highly preferred urethane catalysts are tetramethylbutanediamine (TMBDA), 1,4-diaza(2,2,2)bicyclooctane (DABCO), dibutyltindilaurate (DBTDL) tinoctoate (SnOct), dimorpholine diethylether (DMDEE), or mixtures thereof.

A preferred polyester-ether polyol for use in the above and below described compositions has the formula: 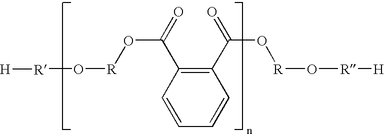
wherein R represents:
(a) alkylene groups of about 2 to about 10 carbon atoms;
(b) —CH₂—R₂—CH₂—
where R₂ represents: 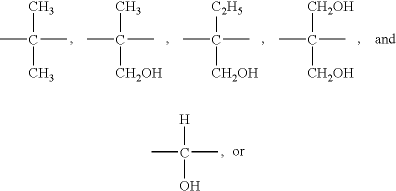
(c) —(R₃O)ₙ₂—R₃—
where each R₃ independently is an alkylene group of about 2 to about 4 carbon atoms, and n2 is an integer of from about 1-200; and
wherein R′ and R″ are independently —[CH₂CH₂O]ₙ₁—, —[CH₂CH(CH₃)O]ₙ₁—, —[CH₂CH₂CH(CH₃)O]ₙ₁—, or a random combination thereof, where n1 is independently about 1-200 for R′ and R″; and wherein n is about 1-200.

The R alkylene groups may be branched or straight chain, saturated or unsaturated, and when R₂ contains a hydroxyl moiety, such hydroxyl group may be optionally alkoxylated.

A highly preferred polyester-ether polyol has the formula: 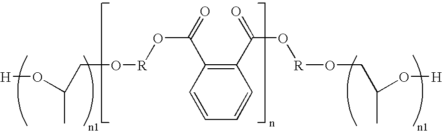
wherein R represents:
(a) alkylene groups of about 2 to about 10 carbon atoms;
(b) —CH₂—R₂—CH₂—
where R₂ represents: 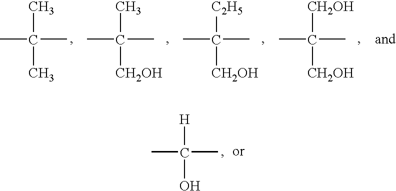
(c) —(R₃O)ₙ₂—R₃—
where each R₃ independently is an alkylene group of about 2 to about 4 carbon atoms, and n2 is an integer of from about 1-200; and
   where n1 is independently about 1-200; and wherein n is about 1-200.

The R alkylene groups may be branched or straight chain, saturated or unsaturated, and when R2 contains a hydroxyl moiety, such hydroxyl group may be optionally alkoxylated.

A most preferred polyester-ether polyol has the formula: 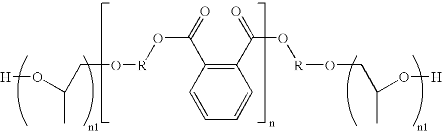
wherein each R is —(CH₂CH₂OCH₂CH₂)—; wherein each n1 is independently about 1-200; and
wherein n=about 1-200.

Specific auxiliary polyester polyols suitable for use in the compositions of the invention include for example phthalic acid diethylene glycol polyester polyols. Suitable auxiliary phthalic acid diethylene glycol polyester polyols are commercially available from Stepan Company, Northfield, Ill. Representative auxiliary polyols are StepanPol® PS-2002 (a phthalic anhydride diethylene glycol polyester polyol having an OHv of 195 and a functionality of 2), StepanPol® PS-3152 (a phthalic anhydride diethylene glycol polyester polyol having an OHv of 315 and a functionality of 2), and StepanPol® PS-4002 (a phthalic anhydride diethylene glycol polyester polyol having an OHv of 400 and a functionality of 2), and mixtures thereof. In the instant invention, by OH value (OHv) is meant hydroxyl value, a quantitative measure of the concentration of hydroxyl groups, usually stated as mg KOH/g, i.e., the number of milligrams of potassium hydroxide equivalent to the hydroxyl groups in 1 g of substance. By functionality is meant the number of reactive groups, e.g., hydroxyl groups, in a chemical molecule.

Other auxiliary polyester polyols, i.e. non-phthalic anhydride-based polyester polyols, include for example, polyester polyols derived from the condensation of caprolactone and a poly alcohol. Specific auxiliary polyether polyols suitable for use in the methods and compositions of the invention include for example the condensation products of propylene glycol/propylene oxide, trimethylolpropane/ethylene oxide/propylene oxide, trimethylolpropane/propylene oxide, sucrose/propylene glycol/propylene oxide, alkylamine/propylene oxide, and glycerin/propylene oxide, and mixtures thereof.

Although not critical to the present invention, the compositions of the present invention may optionally contain from about 0.01 to about 50.0 percent by weight of a cross linking agent. Suitable cross linking agents are, for example, higher functionality alcohols such as triols or pentaerythitol.

A wide variety of urethane catalysts are suitable for use in the present invention. Generally, any urethane catalyst capable of effecting a polymerization to form a urethane CASE may be used in the present invention. Examples of suitable urethane catalysts include, among others, tetramethylbutanediamine (TMBDA), 1,4-diaza(2,2,2)bicyclooctane (DABCO), dibutyltindilaurate (DBTDL) and tinoctoate (SnOct), and mixtures thereof.

Isocyanates useful in the practice of the present technology, include among others for example, polyisocyanates, aliphatic, cycloaliphatic, araliphatic, aromatic and heterocyclic polyisocyanates, such as those described, for example, by W. Siefken in Justus Liebigs Annalen der Chemie 562: 75-136. Examples include ethylene diisocyanate; tetramethylene-1,4-diisocyanate, hexamethylene-1,6-diisocyanate; dodecane-1,12-diisocyanate; cyclobutane-1,3-diisocyanate; cyclohexane-1,3- and 1,4-diisocyanate and mixtures of these isomers; 1-isocyanato-3,3,5-trimethyl-5-isocyanatomethylcyclohexane (German Auslegeschrift No. 1,202,785, U.S. Pat. No. 3,401,190); hexahydrotolylene-2,4- and 2,6-diisocyanate and mixtures of these isomers; hexahydrophenylene-1,3- and/or -1,4-diisocyanate; perhydrodiphenylmethane-2,4′- and/or 4,4′-diisocyanate; phenylene-1,3- and -1,4-diisocyanate; tolulene-2,4- and -2,6-diisocyanate and mixtures of these isomers; diphenylmethane-2,4′- and/or -4,4′diisocyanate; naphthylene-1,5-diisocyanate; triphenyl methane-4,4′,4″-triisocyanate; polyphenyl-polymethylene polyisocyanate which may be obtained by aniline/formaldehyde condensation followed by phosgenation and which have been described, for example, in British Pat. Nos. 874,430 and 848,671; m- and p-isocyanatophenyl sulphonyl isocyanate according to U.S. Pat. No. 3,454,606; perchlorinated aryl polyisocyanate as described, for example, in U.S. Pat. No. 3,277,138; polyisocyanate; containing carbodiimide groups as described in U.S. Pat. No. 3,152,162; the diisocyanates described in U.S. Pat. No. 3,492,330; polyisocyanates containing allophanate groups as described, for example, in British Pat. No. 994,890, Belgian Pat. No. 761, 626 and Published Dutch Patent application No. 7,102,524; polyisocyanates containing isocyanurate groups as described, for example, in U.S. Pat. No. 3,001,973, in German Pat. Nos. 1,022,789; 1,222,067 and 1,027,394 and in German Offenlegungsschriften Nos. 1,929,034 and 2,004,048; polyisocyanates containing urethane groups as described, for example, in Belgian Pat. No. 752,261 or in U.S. Pat. No. 3,394,164; polyisocyanates containing acrylated urea groups according to German Pat. No. 1,230,778; polyisocyanates containing biuret groups as described, for example, in U.S. Pat. Nos. 3,124,605 and 3,201,372; and in British Pat. No. 889,050; polyisocyanates prepared by telomerization reactions as described, for example in U.S. Pat. No. 3,654,016; polyisocyanates containing ester groups as mentioned, for example, in British Pat. Nos. 965,474 and 1,072,956, in U.S. Pat. No. 3,567,763 and in German Pat. No. 1,231,688; reaction products of the above-mentioned isocyanates with acetals according to German Pat. No. 1,072,385; and, polyisocyanates containing polymeric fatty acid groups as described in U.S. Pat. No. 3,455,883, and mixtures thereof.

The distillation residues obtained from the commercial production of isocyanates and which still contain isocyanate groups may also be used, optionally dissolved in one or more of the above-mentioned polyisocyanates.

Other suitable polyisocyanates which are readily available include, for example, toluene-2,4- and -2,6-diisocyanate and mixtures of these isomers (“TDI”); polyphenyl polymethylene polyisocyanates which may be obtained by aniline/formaldehyde condensation followed by phosgenation (“crude MDI”); and, polyisocyanates containing carbodiimide groups, urethane groups, allophanate groups, isocyanurate groups, urea groups or biuret groups (“modified polyisocyanates”), and mixtures thereof.

Somewhat more preferred polyisocyanates are 2,4- and/or 2,4/2,6-toluene diisocyanate, diphenyl methane 4,4′-diisocyanate, hexamethylene diisocyanate, and isophorone diisocyanate, and mixtures thereof.

Suitable polyisocyanurates useful in the present invention also include, as is well known to those skilled in the art, the cyclotrimerization product of any of the aforementioned polyisocyanates.

Compositions of the present invention may contain optional ingredients, including for example, rheology modifiers, plasticizers, pigments, and waxes.

Another embodiment of the present invention includes a novel polyester-ether polyol for use in preparing urethane prepolymers, urethane foams and non-urethane coatings, sealants, adhesives and/or elastomers of the formula: 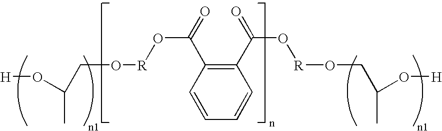
wherein R represents:
(a) alkylene groups of about 2 to about 10 carbon atoms;
(b) —CH₂—R₂—CH₂—
where R₂ represents: 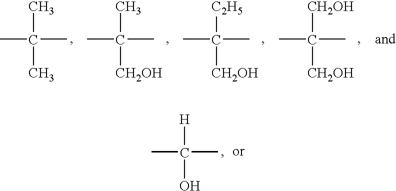
(c) —(R₃O)ₙ₂—R₃—
where each R₃ independently is an alkylene group of about 2 to about 4 carbon atoms, and n2 is an integer of from about 1-200; and
   where n1 is independently about 1-200; and
   wherein n is about 1-200.

The R alkylene groups may be branched or straight chain, saturated or unsaturated, and when R2 contains a hydroxyl moiety, such hydroxyl group may be optionally alkoxylated.

Another embodiment of the present invention includes a novel polyester-ether polyol for use in preparing urethane prepolymers, urethane foams and non-urethane coatings, sealants, adhesives and/or elastomers of the formula: 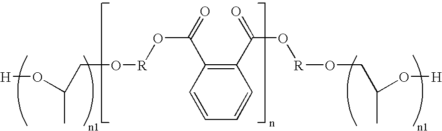
wherein each R is —(CH₂CH₂OCH₂CH₂)—; wherein each n1 is independently about 1-200; and
wherein n= about 1-200.

The instant invention further includes methods for preparing a phthalate polyester-ether polyol comprising combining:

a) about 42% to about 52% based on the weight of phthalate polyester-ether polyol of phthalic anhydride or phthalic acid; and

b) about 33% to about 58% based on the weight of phthalate polyester-ether polyol of at least one polyol of the formula:
HO—R₁—OH
wherein R₁ represents:
   (a) alkylene groups of about 2 to about 10 carbon atoms;
   (b) —CH2-Rb2-CH2—
   where Rb 2 represents: 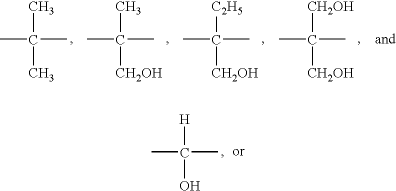
   (c) —(R₃O)ₙ₂—R₃—
   where each R₃ independently is an alkylene group of about 2 to about 4 carbon atoms, and n2 is an integer of from about 1-200,

to form an intermediate polyester-polyol; and alkoxylating said intermediate polyester polyol with about 45% to about 77% based on the weight of the phthalate polyester-ether polyol of an alkoxylating agent to form the polyester-ether polyol. The R₁ alkylene groups may be branched or straight chain, saturated or unsaturated, and when R₂ contains a hydroxyl moiety, such hydroxyl group may be optionally alkoxylated. Further in accordance with this method embodiment, the alkoxylation may be conducted in the presence of a double metal cyanide complex catalyst. The double metal cyanide complex catalyst may be of the formula:
Mₐ¹[M²(CN)_{b}(A)_{c}]_{d}.wM³Dₑ.xH₂O.yL.zHₙEₘ
wherein M¹ represents at least one of Zn(II), Fe(II), Co(II), Ni(III), Mn(II), Cu(II), Sn(II) or Pb(II); M² represents at least one of Fe(II), Fe(III), Co(II), Cr(III), Mn(II), Mn(III), Ir(III), Rh(III), Ru(II), V(IV) or V(V); M³ represents M¹ and/or M²; A, D and E each represent an anion which may be the same or different; L represents an alcohol, aldehyde, acetone, ether, ester, amide, nitrile or sulphide or mixtures thereof; a and d are numbers to satisfy the valency state of M¹ and M² in the double metal cyanide part of the general formula I; b and c are integers (b>c) which together with a and d provide the electroneutrality of the double metal cyanide part of the general formula I; e is an integer satisfying the valency state of M³; n and m are integers satisfying the electroneutrality of HE, and w is a number between 0.1 and 4; x is a number up to 20; y is a number between 0.1 and 6, and z is a number between 0.1 and 5. Alternatively, the double metal cyanide complex catalyst may be of the formula:
Zn₃[Co(CN)₆]₂.wM³X₂.xH₂O.yL.zHX

wherein X represents a halide; M³ represents Zn(II), Co(II) or Fe(II); L represents an alcohol, ether or ester and w is a number between 0.7 and 1.5; x is a number between 2 and 10; y is a number between 1.5 and 3, and z is a number between about 0.15 and 1.5. In yet another embodiment, the double metal cyanide complex catalyst is of the formula:
Zn₂[Co(CN)₆]Cl-0.5HCl-DME-2.75H₂O.

Combinations of the various metal catalysts may optionally be used. Additionally, the invention relates to a polyester-ether polyols produced by the above methods using the metal catalysts disclosed.

The instant invention further includes methods for preparing urethane prepolymers, urethane foams and non-foam urethane coatings, adhesives, sealants and/or elastomers, comprising combining:

(a) from about 10% to about 60% based on the weight of the composition of an isocyanate;

(b) from about 0.02% to about 5.0% based on the weight of the composition of a urethane catalyst; and V

(c) from about 23% to about 55% based on the weight of the composition of a phthalate polyester-ether polyol which is the reaction product of:
(1) about 42% to about 52% based on the weight of phthalate polyester-ether polyol of phthalic anhydride or phthalic acid; and
(2) about 33% to about 58% based on the weight of phthalate polyester-ether polyol of at least one polyol of the formula:
   HO—R₁—OH
wherein R₁ represents:
   (a) alkylene groups of about 2 to about 10 carbon atoms;
   (b) —CH2-R2-CH2
   where R2 represents: 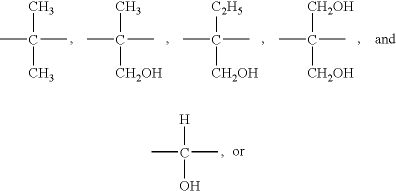
   (c) —(R3O)n2-R3—
where each R3 independently is an alkylene group of about 2 to about 4 carbon atoms, and n2 is an integer of from about 1-200; and
(3) about 45% to about 77% based on the weight of phthalate polyester-ether polyol of an alkoxylating agent; and

(d) from 0% to about 50% based on the weight of the composition of an auxiliary polyether polyol, polyester polyol, or a mixture thereof;

(e) from 0% to about 10% based on the weight of the composition of a blowing agent;

(f) from 0% to about 5% based on the weight of the composition of a compatibilizing surfactant,

to form a mixture; and reacting/polymerizing the mixture to form a urethane prepolymer, urethane foam or non-foam urethane coating, adhesive, sealant and/or elastomer. The polyester-ether polyol is preferably the reaction product of phthalic anhydride or phthalic acid, the polyol, and the alkoxylating agent, wherein the phthalic anhydride or phthalic acid and the polyol are first reacted to from an intermediate polyester polyol, which is subsequently reacted with the alkoxylating agent to give the polyester-ether polyol.

Another embodiment of the present invention includes urethane prepolymers, urethane foams and non-foam urethanes suitable for use in a coatings, adhesives, sealants and/or elastomers which are made from polymerizing the compositions suitable for preparing such materials as described herein.

The merits of this invention are further supported by the following non-limiting and illustrative examples.

### EXAMPLES

As used in the Examples and description appearing below, the following designations, symbols, terms and abbreviations have the indicated meanings:

| Material | Description |
|---|---|
| STEPANPOL ® | ˜200 OHv; phthalic anhyride/diethlyene glycol |
| PS-2002 | polyester; Acid Number = 0.64 |
| TONE 0201 | ˜200 OHv; polycaprolactone glycol; Acid Number = |
| | 0.13 |
| Formrez ® | ˜200 OHv; diethylene glycol/adipic acid polyester |
| 11-225 | glycol |
| “Liquid” | methylene-diphenylene isocyanate |
| MDI | |
| Voranol | The product of propoxylation of propylene glycol to |
| 220-056N | an approximate hydroxyl value of 56.1 mg KOH/g. |
| | Residual potassium, the catalyst for the |
| | propoxylation at ca., 0.2% by weight of the final |
| | product, is typically removed by adsorption of |
| | potassium on magnesium silicate which is in turn |
| | removed from the product by filtration. About 50 |
| | ppm (parts per million) of phosphoric acid are then |
| | added to the final polypropylene glycol to assure |
| | the product is not basic. |
| Voranol | Voranol 220-110N with no addition of phosphoric |
| 220-110 | acid |
| Magnesol | Magnesium silicate; manufactured by the Dallas |
| | Group of Indiana; a hydrated, synthetic, amorphous |
| | magnesium silicate with a porous structure and |
| | active surface that imparts high performance, |
| | selective, and sorptive properties; its highly active |
| | surface attracts sodium, potassium, and other |
| | metal ions as well as other polar compounds by |
| | chemisorption and holds them for removal from the |
| | process by filtration |

In the following examples, all amounts are stated in percent by weight of active material unless indicated otherwise. One skilled in the art will recognize that modifications may be made in the present invention without deviating from the spirit or scope of the invention. The invention is illustrated by the examples contained within; such examples are not to be construed as limiting the invention or scope of the specific procedures or compositions described herein.

The following raw materials in Table I were used without purification in the examples which follow (abbreviations used are PA phthalic anhydride, DEG=diethylene glycol, PPG=polypropylene glycol, PPO=polypropylene oxide, Gyl=glycerin, Su=sucrose, OHv=hydroxyl value in mg KOH/g). Polyols A and B are commercially available polyester polyols used as comparative examples as indicated below.

TABLE I

| Desig- | | | |
|---|---|---|---|
| nation | Product Name | Supplier | Description |
| Polyol A | Voranol 220-056N | Dow USA | 55.7 mg KOH/g OHv PPG |
| Polyol B | Voranol 220-110 | Dow USA | 108.9 mg KOH/g OHv |
| | | | PPG |
| Isocyanate | Mondur M, Flaked | Bayer | 4,4′-diphenylmethane |
| | | | diisocyanate |
| DBTDL | Dibutyl tin | Air | Organotin catalyst |
| | dilaurate | Products | |
| Extender | 1,4-butane diol | Air | Chain extender glycol |
| | | Products | |

As shown in Table II, polyol C (comparative example) is a standard PA-DEG polyol (StepanPol PS-2002) and polyols D and E are examples of polyester-ether polyols. Both these polyols were prepared by the propoxylation of a ortho-phthalate diethylene glycol ester (StepanPol PS-2002).

TABLE II

| Designation | Description |
|---|---|
| Polyol C | 52.5 mg KOH/g OHv PA- DEG glycol |
| Polyol D | 62 mg KOH/g OHv PA- DEG-propoxylate |
| Polyol E | 87 mg KOH/g OHv PA- DEG propoxylate |

### Example 1

### Preparation of Polyester Polyol C (Comparative Example; STEPANPOL® PS-2002)

PS-2002 is prepared as the condensation product of about 45% diethylene glycol (DEG) and 55% phthalic anhydride. Into a three gallon kettle is charged 4500 g of DEG and 5500 g PA. This mixture is heated to about 180° C. for four hours under a nitrogen atmosphere. After four hours the temperature is raised to about 180-200° C., and approximately 500 ppm of catalyst tetrabutyl titinate (Tyzor TBT, DuPont) is added to the kettle. The pressure is reduced in the kettle and removal the water by-product is begun under vacuum. The water is completely removed after about 24 hours of reaction at about 180-200° C. under vacuum. The final polyester polyol is characterized by a hydroxyl number of 190-200 mg KOH/g and has a Brookfield viscosity of about 20,000-30,000 cPs at 25° C. and an acid value less than 1 mg KOH/g.

### Example 2

### Preparation of Polyester-Ether Polyol D (Propoxylated Ortho-phthalate diethylene glycol ester)

Into a two gallon steel pressure Chemineer kettle is charged 3678 grams StepanPolâ PS-2002 and 155 grams of crushed potassium hydroxide. The mixture is blended under a nitrogen blanket for 2 hours at 120° C. A total of 7,060 grams of propylene oxide is added under a pressure of <42 psig over three hours at a temperature of about 120-125° C. A total of 500 grams of this crude product is then transferred to a flask where it is then heated to about 100° C. and degassed to remove unreacted propylene oxide. The material is then finished/neutralized: To the remaining warm mixture, 1.5 grams of Magnesol HMR-LS (The Dallas Group) is added and the mixture is then stirred at about 100-120° C. for four hours. The resulting mixture is allowed to stand warm (80° C.) for approximately 12 hours and the product is decanted and filtered through a vacuum flask equipped with a Buchner funnel and a #4 Whatman filter paper. Approximately 0.1% H3.PO4 (85%) by weight of the polyol is then added. Analysis of polyol D gave the following properties:

OH value = 87 mg KOH/g (ASTM E 222 method)
Dynamic viscosity = 1,200 cP @ 25° C. (Brookfield, #31 spindle)
% moisture = 0.068% (ASTM D 4672 method)
% Propylene oxide = 55% by weight

### Example 3

### Preparation of Polyester-Ether Polyol E (Propoxylated Ortho-phthalate diethylene glycol ester)

Polyol E is prepared in a similar manner to that of polyol D, except the amounts of materials used are 14.5 g KOH, 2890 g, StepanPol PS-2002 and 6010 g propylene oxide. Analysis of polyol E gave the following properties:

OH value = 59.4 mg KOH/g (ASTM E 222 method)
Dynamic viscosity = 1,400 cP @ 25° C. (Brookfield, #31 spindle)
% Propylene oxide = 69% by weight
% Moisture = 0.023% (ASTM D 4672 method)

### Example 4

### Preparation of Polyester-Ether Polyol F (Propoxylated Ortho-phthalate diethylene glycol ester)

Polyol F was prepared in a similar manner to than of Polyol E, but with a 128 mg KOH/g PA-DEG polyol as an initiator (438 g/eq); the initiator used is 2,965 grams of a 128 Ohv PA-DEG polyol, along with 20.1 g of 45% KOH (aqueous) and 2,360 grams of propylene oxide to give a propoxylated polyester ether polyol with an OH value of 82 mg KOH/g and subsequently finished/neutralized as described in Example 2 above. Analysis of polyol E gave the following properties:

OH value = 83.5 mg KOH/g (ASTM E 222 method)
Dynamic viscosity = 22,050 cP @ 25° C. (Brookfield, #31 spindle)
% Propylene oxide = 34.9% by weight
% Moisture = 0.11% (ASTM D 4672 method)

### Example 5

### Preparation of Polyester-Ether Polyol G (Propoxylated Ortho-phthalate diethylene glycol ester)

Polyol G is prepared in a manner similar to Polyol F (2,965 grams of a 128 Ohv PA-DEG initiator, 20.1 grams of 45% KOH), but propoxylated (6,360 grams of propylene oxide) to an OH value of 53.8 mg KOH/g and subsequently finished/neutralized. Analysis of polyol E gave the following properties:

OH value = 53.8 mg KOH/g (ASTM E 222 method)
Dynamic viscosity = 4,710 cP @ 25° C. (Brookfield, #31 spindle)
% Propylene oxide = 58% by weight
% Moisture = 0.02% (ASTM D 4672 method)

Prepolymer Preparation

Prepolymers are generally prepared by the reaction of a polyol with an isocyanate at about 60-70° C. over a two hour period in a reactor equipped with agitation means and a slow nitrogen pad. The polyol is first warmed to 80° C. followed by the addition of the required amount of isocyanate flakes to form a mixture. The mixture is then sealed and allowed to cool over a 12 hour period to about 25° C.; the weight percent of unreacted isocyanate (% NCO) is then determined in accordance with test ASTM D 2582-80.

Dynamic viscosity is determined with a Brookfield RVT viscometer equipped with a # 31 spindle, Thermocel and temperature controller. Table III gives the prepolymer nomenclature, formulations and results.

TABLE III

| | | | | Final |
|---|---|---|---|---|
| Prepolymer | Polyol Used and | Amount of MDI | | Prepolymer % |
| Reference | amount | used | | NCO |
| H | Polyol A, 406.4 grams | 393.6 | grams | 13.96 |
| I | Polyol B, 389.6 grams | 410.4 | grams | 14.85 |
| J | Polyol D, 290 grams | 309 | grams | 14.67 |
| K | Polyol C, 200 grams | 205 | grams | 14.75 |

Elastomer Preparation

Elastomers are prepared by hand mixing the appropriate amount of prepolymer (H-J) with 1,4-butane diol for approximately 15 seconds, followed by the addition of one drop of DBTDL catalyst and approximately 10 seconds of additional hand mixing and casting into metal molds which are preheated to about 120° C. Elastomer parts were cured by placing the mold in a 120° C. oven for one hour, followed by removal and allowing the mold and contents to cool about 25° C. for at least four hours before extracting parts. Table IV gives formulation data for the elastomer samples (L-N).

TABLE IV

| Elastomer | | | |
|---|---|---|---|
| Designation | Prepolymer and amount | Amount of 1,4-butanediol | |
| L | H, 310 grams | 45 | grams |
| M | I, 170 grams | 22.7 | grams |
| N | J, 294.9 grams | 45 | grams |

Adhesion Sample Preparation

Adhesion samples were prepared by moistening 1″×2″ stainless steel strips (Q-Panel Lab Products) with a small amount of prepolymer (Table II) and then pressing a wood tongue depressor, by means of a five pound weight, onto the steel strip for 12 hours to form a bonded sample. The bonded samples were then evaluated using a “Pull apart test” approximately 24 hours later to classify the method of failure, as detailed more fully as described below. The “Pull apart test” entails bonding two surfaces together with a particular material, allowing the bond to dry/cure at room temperature (i.e., 25° C.) for approximately 24 hours, grasping both surfaces (one in each hand) and pulling the surfaces apart, followed by visual qualitative observation of the previously bonded surfaces to look for torn substrate fragments (substrate failure), torn adhesive (cohesive failure) or one clean surface (adhesive failure).

Elastomer Sample Evaluation

Elastomers prepared in Table IV were evaluated for Tensile Strength (ASTM D 638-91 method), Elongation (ASTM D 638-91 method) and Shore A and Shore D Hardness (ASTM D-2240-91 method). The results are presented below.

| | Elastomer L | Elastomer M | Elastomer N |
|---|---|---|---|
| Tensile Str. (psi) | 1614 | 1294 | 2163 |
| Elongation (%) | 269 | 96 | 84 |
| Shore A/D Hardness | 94/50 | 96/49 | 97/60 |

As can be seen by the above results, the formulation prepared from inventive Polyol D (in Elastomer L) exhibits greater tensile strength and elongation than that of Elastomer M, prepared from the conventional Polyol A, even though both specimens exhibit the same hardness.

Prepolymer Viscosity Evaluation (Brookfield RVT,
#31 spindle, cP @ 25° C.)

| Prepolymer J | Prepolymer H | Prepolymer I | Prepolymer K |
|---|---|---|---|
| 2250 | 1035 | 2340 | 25,500 |

As can be seen by the above results, the corresponding prepolymer of a pure PA-DEG polyester polyol is approximately 25,500 cP @ 25° C., where as the prepolymer of the polyester-ether polyol material is less than 10% of that viscosity, a highly desirable characteristic.

Adhesion Evaluations

For the metal-wood bond sample formed with prepolymer H, the failure method was cohesive; i.e., as an attempt was made to separate the wood and metal members by hand, both the wood and metal separated in tact, visibly undamaged and with adhesive residue on both the formerly bonded wood and metal surfaces.

For the metal-wood bond formed with Prepolymer J, the failure method was substrate; i.e., as an attempt was made to separate the wood and metal by hand, the wood split, leaving fragments of wood bonded to the metal.

In accordance with these qualitative results, substrate failure is almost always preferred in structural (load-bearing members) bonding, since the adhesive is stronger than one of the substrates. Here, the PPG-prepolymer/adhesive failed undesirably, as compared to the prepolymer made from the novel polyester-ether polyol, i.e. the material gave a more desirable failure.

Solubility Evaluations

The following polyol materials shown in Table V were used to explore the solubility, i.e., compatibility, of polyester-ether polyols of the present technology in other various ester- and ether-based polyols.

TABLE V

| Desig- | Polyol | OH | | | |
|---|---|---|---|---|---|
| nation | Name | value | Source | Description | Class |
| AA | Voranol | 106.9 | Dow | Polypropylene | Polyether |
| | 220-110 | | | glycol | |
| BB | Voranol | 55.28 | Dow | Polypropylene | Polyether |
| | 220-056 | | | glycol | |
| FF | Voranol | 57.1 | Dow | Glycerin- | Polyether |
| | 230-056 | | | polypropylene | |
| | | | | oxide triol | |
| GG | Voranol | 373 | Dow | Sucrose-glycerin | Polyether |
| | 370 | | | polypropylene | |
| | | | | oxide polyol | |
| HH | PolyG | 36.94 | Olin | Glycerin- | Polyether |
| | 85-36 | | | polypropylene | |
| | | | | oxide triol, | |
| | | | | ethylene oxide | |
| | | | | capped | |
| II | StepanPol | 195 | Stepan | Phthalic anhydride- | Polyester |
| | PS-2002 | | | diethylene glycol | |
| JJ | StepanPol | 315 | Stepan | Phthalic anhydride- | Polyester |
| | PS-3152 | | | diethylene glycol | |
| KK | Terate | 237 | Cape | Diethylene glycol | Polyester |
| | 2541 | | | terephthalate | |
| LL | Tone | 61.49 | Union | Polycaprolactone | Polyester |
| | 0240 | | Carbide | | |

Blends of Polyol E and each of polyols in Table V above are made at weight ratios of 25:50 grams, 50:50 grams and 75:50 grams, respectively, in six ounce, open-mouth, clear flint glass jars. Similar blends are made with Polyol G. In each case (at each weight ratio), all the mixtures were visibly clear (formed soluble systems).

When Polyol E (or polyol G) are replaced in an identical series of experiments with either Polyols I, J, or N no solubility at any level was observed with any of the polyether polyols (A, B, F, G, H).

Polyol D will dissolve in either polyether or polyester glycols which is necessary to make stable two-part systems. Essentially, PA-DEG propoxylated to 55-58% propylene oxide by weight will be soluble in either ether or ester glycols. More propylene oxide by weight makes the product soluble on PPGs only; less PO with an ester is soluble only in ester glycols.

Polyester-Ether Polyol Preparation Using Double Metal Cyanide Catalyst Control/Comparative General Procedure Description

Polyester polyol initiator (such as PS-2002) is combined with KOH as catalyst (either 45% aqueous solution or powdered KOH may be utilized; if added as a solution, water is stripped to ≦0.10 wt. % after addition of the catalyst). This polyester polyol-catalyst solution is charged into a 2-gallon, stainless steel Chemineer alkoxylator reactor. Propylene oxide (PO) is added to the reactor to maintain the following conditions: ≦125° C. temperature, ≦75 psi pressure, with initial N2 pressure of 2-3 psi. After addition of PO—the reaction is “digested”—continued to react without further addition of PO—with agitation until the rate of pressure decrease observed for the reaction stabilizes. The reactor is then vented, purged with N2, and the contents are drained for further treatment.

The product of the propoxylation is vacuum stripped to remove any unreacted PO still present. Hydrogen peroxide is then added to improve the product's color. The product is then treated with Magnesol to remove the potassium catalyst, with stirring for at least one hour (to permit contact of Magnesol with water), vacuum stripped (to remove water added by Magnesol), and filtered (to remove the Magnesol/potassium amalgamated solids).

### Example A

### Using Standard KOH as Catalyst

To approximately 3013 g of PS-2002 polyol in a reactor equipped with agitation, N₂ sparging, heat, and vacuum was added approximately 49.8 g of 45% aq. KOH solution (at KOH level of 0.2 wt-%-by-final-product-weight). The resulting solution was stripped to remove water under full vacuum at ≦130° C. for about 30 minutes (until water evolution stopped).

Next, approximately 2847 g of the above solution was charged into alkoxylator reactor. Then, as outlined above, approximately 1745 g of PO (6 mole PO/mole polyester diol) were added over 250 minutes, at an approximate rate of addition of about 330 g/hr of PO. Digestion with agitation was accomplished in about 2 hours and the time for subsequent neutralization and removal of the potassium was about 6 hours. The final product was treated with approximately 0.04 wt. % H₂O₂, based on the weight of the final product, to improve color, followed by treatment with Magnesol (2.0%-by-wt.) to remove the potassium catalyst, stirred for at least one hour (to permit contact of Magnesol with water), vacuum stripped (to remove water), and filtered (to remove the Magnesol/potassium amalgamated solids).

Inventive Description and General Procedure (Using Double Metal Cyanide (DMC) Catalyst)

Polyester polyol initiator (such as PS-2002) is combined with the desired amount of DMC compound as catalyst. Generally, no stripping is necessary as no appreciable water is present. Then, the polyester polyol-catalyst solution is charged into a 2-gallon, stainless steel Chemineer alkoxylator reactor. Propylene oxide (PO) is then added to the reactor to maintain the following conditions: ≦125° C. temperature, ≦75 psi pressure, with initial N2 pressure of 2-3 psi. After addition of PO, the reaction is “digested”—continued to react without further addition of PO—with agitation until the rate of pressure decrease observed for the reaction stabilized. The reactor is then vented, purged with N2, and the contents are drained for further treatment as desired. The product of the propoxylation is vacuum stripped to remove any unreacted PO still present.

A slight amount of hydrogen peroxide (e.g., 0.04%-by-wt.) may optionally be added to improve the product's color. The product may also be optionally treated with a sufficient amount of Magnesol (e.g., 2.0%-by-wt.) to remove the catalyst, stirred for at least one hour (to permit contact of Magnesol with water), vacuum stripped (to remove water), and filtered (to remove the Magnesol/catalyst amalgamated solids).

### Inventive Example B

### Using Double Metal Cyanide Catalyst

To approximately 3491 g of PS-2002 was added 10.3 g of DMC compound (at catalyst level of 0.2 wt-%-by-final-product-weight); this solution was then charged into the alkoxylator reactor. Then, as outlined above, approximately 2115 g of PO (6 mole PO/mole polyester diol) were added over 90 minutes, at a rate of addition of about 2950 g/hr of PO. While the material was digested for two hours (to replicate conditions of above control), the pressure had stabilized after 30 minutes of digestion. No additional time was required for subsequent handling of the material—no unreacted PO was found to be present. Approximately 0.04 wt. percent hydrogen peroxide was added to improve the product's color. The product was also treated with 2.0 wt. percent Magnesol, stirred for one hour, vacuum stripped, and filtered (to remove the Magnesol/catalyst amalgamated solids).

### Inventive Example C

### Using Double Metal Cyanide Catalyst

To approximately 3168 g of a polyester polyol (99.5 OHV, 13.8 AV, PA/Glycerine/DEG polyester triol) was added 10.0 g of DMC compound (at catalyst level of 0.18 wt-%-by-final-product-weight); this solution was charged into the alkoxylator reactor. Then, as outlined above, approximately 2460 g of PO (22.6 mole PO/mole polyester diol) was added over 125 minutes, at a rate of addition of about 1225 g/hr of PO. The material was digested for two hours. The time for subsequent handling of the material was about 30 minutes—only stripping of unreacted PO was necessary. No hydrogen peroxide was needed to improve the product's color and no Magnesol was required to remove the catalyst.

Comparison of KOH-Catalyzed Polyester-ether Polyols

As mentioned above, EO and PO behave very differently during alkoxylation reactions, even when the same catalyst is used. This is illustrated in the following Example D using standard KOH as catalyst.

### Example D

### Using Standard KOH as Catalyst

KOH was used to alkoxylated STEPANPOL® PS-2002, a phthalic anhydride diethylene glycol (PA-DEG) polyester polyol having an OH value of about 195 and a functionality of about 2. Four polyester-ether polyols (Polyols 1-4) were produced by ethoxylation (Polyols 1 and 2) or propoxylation (Polyols 3 and 4) of STEPANPOL® PS-2002 using KOH as the catalyst. Their theoretical OH values, actual measured OH values, and the differences between them are shown in Table VI below. The OH_{theory} means the theoretical or projected hydroxyl value of a polyester-ether polyol based on the amounts of STEPANPOL® PS-2002 and PO used to make the polyester-ether polyol; OH_{measured} means the actual measured hydroxyl value of the polyester-ether polyol.

TABLE VI
KOH-Catalyzed Polyester-ether Polyols
(OH values are in mg KOH/g)

| | Polyol | Polyol | Polyol | Polyol |
|---|---|---|---|---|
| | I (EO) | 2 (EO) | 3 (PO) | 4 (PO) |
| OH_{Theory} | 81 | 61 | 67 | 110 |
| OH_{Measured} | 88 | 66 | 87 | 136 |
| Difference: OH_{Measured} − | 7 | 5 | 20 | 26 |
| OH_{theory} | | | | |

The results recorded in Table VI above illustrate that (1) EO and PO behave very differently in alkoxylation reactions of phthalate polyester polyols; and (2) saponification was a much more serious problem for propoxylating STEPANPOL® PS-2002 than for ethoxylating the same polyester polyol when a base such as KOH is used as the catalyst. The results show that when KOH was used as the catalyst to propoxylate a polyester polyol, the propoxylation reaction was inefficient due to the concurrent saponification reaction. See Table VI.

The behaviors of polyester polyols and polyether polyols in alkoxylation reactions are also very different. Saponification is a problem for propoxylation of polyester polyols, but is not a problem for propoxylation of polyether polyols.

Further, alkoxylated polyester polyols (i.e., polyester-ether polyols) of the present application and alkoxylated polyether polyols (i.e., polyoxyalkylene polyether polyols) of the prior art are not comparable. The property differences between polyester-ether polyols and polyoxyalkylene polyether polyols are illustrated in the following example, in which a polyester polyol and a polyether polyol were propoxylated using a DMC catalyst.

### Example E

About 3014 g of STEPANPOL® PS 2002 diethylene glycol phthalate (Stepan Company; OHV —196.4 mg KOH/g; equivalent weight =285.6 g/equivalent), 3.41 g of a DMC catalyst (SIBERCAT® DMC-J, DSKH), and 3.31 g of TYZOR® TnBT (DuPont) were charged into a 2-gallon Chemineer alkoxylator. Vacuum stripping of the charge was conducted at about 150° C. under 20 mm Hg for approximately 5.0 hours. The final moisture was measured as 0.03% by weight. A pressure/vent cycle (35/5 psig of nitrogen) was conducted three times prior to propoxylation. The reaction temperature for propoxylation was about 125-135° C. until initiation, then allowing the reaction to exotherm to 1700 C and maintaining the reaction temperature at 165-170° C. until complete. Propylene oxide (PO; 4975 g) was charged to the reactor. Initiation of the DMC catalyst occurred after 3.5 hours (26.73% PO by weight). The reaction was digested (allowed to complete reaction) for approximately 1.0 hour, and the total reaction time was about 8.0 hours. The product was cooled to 50° C., and about 30.3 g of ISONOX® 132, was added and mixed in. The final product, which is a polyester-ether polyol (Polyol 5), was a liquid with an OH value of 70.0 mg KOH/g.

### Example F

The procedure described in Example E was duplicated with about 4217 g of ARCOL® PPG-425 polyether glycol (Bayer MaterialScience, LLC, Pittsburgh, Pa.; OHV=261 mg KOH/g, equivalent weight=214.9 g/equivalent) replacing STEPANPOL® PS-2002. About 6.5 g of DMC catalyst, 6.4 g of TYZOR® TnBT catalyst, 11420 g of propylene oxide and 63.5 g ISONOX 132 were used. The final product, which is a polyoxyalkylene polyether polyol (Polyol 6), was a liquid with an OH value of 70.1 mg KOH/g.

Polyols 5 and 6 were then studied by mixing 50 g of Polyol 5 or 6 with 10 g of STEPANPOL® PS-4002, which is a diethylene glycol phthalate (Stepan Company, OHV=390.1 mg KOH/g, equivalent weight =143.8 g/equivalent). The mixture was blended by hand. It was observed that the mixture containing 50 g Polyol 5 was a clear mixture, indicating compatibility; the mixture containing 50 g Polyol 6, on the other hand, was a white, opaque mixture, indicating incompatibility.

Due to the structural and property differences between polyester polyols and polyether polyols, and due to the structural and property differences between polyester-ether polyols and polyoxyalkylene polyether polyols, it is unpredictable how polyester polyols will behave with DMC catalysts, and whether they can be propoxylated successfully using DMC catalysts.

In Example G below it can be seen that the DMC catalyst can readily initiate the intermediate polyester polyol (e.g., STEPANPOL® PS-2002) of the present technology, which is a mixture of moderate to low molecular weight polyols, and can quickly and completely catalyze the propoxylation reaction. This result was completely unexpected since it is a common belief among those skilled in the art that DMC catalysts cannot readily initiate alkoxylation reactions in the presence of low molecular weight polyols such as ethylene glycol, diethylene glycol, propylene glycol, dipropylene glycol, glycerine etc. See. eg, Polyols Derived from Double Metal Cyanide Catalysts, UTECH 2000.

### Example G

Two propoxylated phthalate polyester-ether polyols (Polyols 7 and 8) were prepared using KOH catalyst and a DMC catalyst, respectively. In this Example, the total amount of the initiator, STEPANOL® PS-2002, was charged to a reactor, followed by the entire catalyst charge and vacuum degassing to dry the mixture. A calculated amount of propylene oxide (PO) was then added at the reaction temperature until the addition was complete; the hydroxyl value was then measured for each polyol. If the measured hydroxyl values were unacceptably high (as in the case when saponification is significant), additional PO was added based on these hydroxyl value measurements to approach the target OH value. The results are shown below in Table VII.

TABLE VII
KOH-Catalyzed vs. DMC-Catalyzed Polyester-ether Polyols (OH values are
in mg KOH/g; percentages are by weight of the total of PS-2002 and PO)

| | | PS-2002 | | | | Difference: | Polyol | Polyol |
|---|---|---|---|---|---|---|---|---|
| | Catalyst | OH/% | PO | | | OH_{Measured} − | PA | Color |
| | (lb) | (lb) | % (lb) | OH_{Theory} | OH_{Measured} | OH_{Theory} | (wt %) | (Gardner) |
| Polyol 7 | 45% KOH | 195/31.6 | 67.7 | 61.6 | 73.5 | 11.9 | 15.4 | 13 |
| | (266) | (12520) | (26856) | | | | | |
| Polyol 8 | DMC | 193/36.3 | 63.7 | 70.0 | 70.1 | 0.1 | 17.7 | 1 |
| | (20) | (16290) | (28600) | | | | | |

The results recorded in Table VII show that the difference between the measured OH value and theoretical OH value of the KOH-catalyzed Polyol 7 is as high as 11.9, and the difference between the measured OH value and theoretical OH value of the DMC-catalyzed Polyol 8 is only 0.1. This clearly demonstrates that while saponification is a serious problem for the KOH-catalyzed propoxylation reaction, saponification is substantially avoided in the DMC-catalyzed propoxylation reaction of the present application.

The results in Table VII also show that because of saponification of the ester groups in the intermediate polyester polyol (STEPANOL® PS-2002), substantially more PO (67.7% vs. 63.7%) was needed to complete the propoxylation reaction when KOH was used as the catalyst than when the DMC catalyst was used. More required amounts of PO mean a longer reaction time, darker product and less weight percent of the phthalic anhydride ester (PA) component (15.4% vs. 17.7%) in the final product. The polyester-ether polyols of the present application (e.g., Polyol 8) are therefore unexpectedly superior products to the polyester-ether polyols catalyzed using a standard KOH catalyst (e.g., Polyol 7).

### Example H

In this Example H additional polyester polyols, made by reacting differing amounts of phthalic anhydride and differing amounts of DEG polyol, were propoxylated with differing amounts of propylene oxide using DMC as the catalyst. The details for each polyester-ether polyol prepared and the results obtained are set forth in Table VIII below.

TABLE VIII

| | | | | | | Difference | | |
|---|---|---|---|---|---|---|---|---|
| | | PS-2002 | PO used | OH_{Theory} | OH_{Measured} | OH_{Measured} | | Polyol |
| | Catalyst | OH/% | % | mg | mg | mg − | Polyol PA | Color |
| | (amount) | (amount) | (amount) | KOH/g | KOH/g | OH_{Theory} | (wt %) | Gardner |
| Polyol 9 | DMC | 166.4/42.4 | 57.6 | 70.0 | 70.3 | 0.3 | 22.4 | 1 |
| | (2.8 g) | (3247 g) | (4480 g) | | | | | |
| Polyol 10 | DMC | 166.4/54.6 | 45.4 | 90 | 87.9 | −2.1 | 28.9 | 1 |
| | (2.5 g) | (4860 g) | (4035 g) | | | | | |
| Polyol 11 | DMC | 196.4/28.5 | 71.5 | 56 | 54.6 | −1.4 | 14.6 | 1 |
| | (2.7 g) | (4667 g) | (16367 g) | | | | | |
| Polyol 12 | DMC | 166.4/23.1 | 76.9 | 50.0 | 48.0 | −2.0 | 23.1 | 1 |
| | (2.8 g) | (3247 g) | 10806 g) | | | | | |

The results demonstrate that the DMC catalyzed propoxylation substantially avoids the saponification problem over differing ranges of phthalic anhydride, DEG polyol and propylene oxide, and results in a light-colored final product.

### Example I

In this Example, polyester polyols made by reacting phthalic anhydride with other polyols, e.g., glycerin and trimethylol propane, in addition to the DEG polyol, were propoxylated using a DMC catalyst. The details for each polyester-ether polyol prepared and the results obtained are set forth in Table IX below.

TABLE IX

| | | | | Wt. % | Phthalate | Phthalate | Wt. % | Propoxylate | Rnx |
|---|---|---|---|---|---|---|---|---|---|
| | Functional | Wt. % | Wt. % | Funct. | OH value, | Acid value, | PO | AV, mg | Tim |
| Reference | Monomer | PA | DEG | Monomer | mg KOH/g | mg KOH/g | added | KOH/g | Hours |
| Polyol 13 | Glycerin | 42.7 | 44.9 | 12.4 | 366 | 1.8 | 65 | 0.05 | 5.43 |
| Polyol 14 | Glycerin | 46.6 | 33.3 | 20.1 | 405 | 1.83 | 65 | 0.2 | 6.12 |
| Polyol 15 | Glycerin | 48.1 | 39.3 | 12.6 | 282 | 0.36 | 65 | 0.11 | 2.37 |
| Polyol 16 | Glycerin | 48.1 | 39.3 | 12.6 | 288 | 1.72 | 65 | 0.07 | 4.00 |
| Polyol 17 | TMP | 47.3 | 33.9 | 18.8 | 242 | 0.69 | 65 | 0.03 | 5.77 |
| Polyol 18 | TMP | 46.5 | 42.2 | 11.3 | 251 | 2.43 | 65 | 0.3 | 6.37 |
| Polyol 19 | TMP | 48.0 | 42.1 | 9.0 | 185 | 0.56 | 65 | 0.01 | 5.95 |

In this Example, the results are expressed in terms of acid value, instead of OH value. When a phthalate is propoxylated, the acid value is expected to decrease since the propoxylation just dilutes the acid groups. An increase in acid value, however, supports significantly attendant saponification. From the above results, it can be seen that the acid value of the propoxylate was reduced compared to the phthalate acid value, indicating that use of the DMC catalyst substantially avoided the saponification problem caused by the use of a KOH catalyst to propoxylate polyester polyols.

All documents, e.g., patents and journal articles, cited above or below are hereby incorporated by reference in their entirety.

From the foregoing, it will be appreciated that although specific embodiments of the invention have been described herein for purposes of illustration, various modifications may be made without deviating from the spirit or scope of the invention.

1. A urethane prepolymer, urethane foam, or non-foam urethane for use in coatings, adhesives, sealants or elastomers, made by polymerizing a composition comprising:
(A) from 0% to about 5.0% based on the weight of the composition of a urethane catalyst;
(B) from about 23% to about 55% based on the weight of the composition of a phthalate polyester-ether polyol which is the reaction product of:
(1) an intermediate polyester polyol that is the reaction product of:
(i) about 42% to about 52% based on the weight of the intermediate polyester polyol of phthalic anhydride, phthalic acid or a mixture thereof; and
(ii) about 33% to about 58% based on the weight of the polyester polyol of at least one polyol selected from the group consisting of ethylene glycol, diethylene glycol, propylene glycol, dipropylene glycol, neopental glycol, 1,4-butanediol, 1,6-hexanediol, glycerine, trimethylol propane and tetramethylene glycol;
(2) about 45% to about 77% based on the weight of the phthalate polyester-ether polyol of propylene oxide; and
(3) an effective amount of a double metal cyanide complex catalyst;
(C) from 0% to about 50% by weight of an auxiliary polyether polyol, polyester polyol, or a mixture thereof;
(D) from 0% to about 10% based on the weight of the composition of a blowing agent;
(E) from 0% to about 5% based on the weight of the composition of a compatibilizing surfactant; and
(F) an effective amount of at least one isocyanate.

2. A method for preparing a urethane prepolymer, urethane foam, or non-foam urethane for use in coatings, adhesives, sealants or elastomers, comprising:
(I) combining:
(A) from 0% to about 5.0% based on the weight of the composition of a urethane catalyst;
(B) from about 23% to about 55% based on the weight of the composition of a phthalate polyester-ether polyol which is the reaction product of:
(1) an intermediate polyester polyol that is the reaction product of:
(i) about 42% to about 52% based on the weight of the intermediate polyester polyol of phthalic anhydride, phthalic acid or mixtures thereof; and
(ii) about 33% to about 58% based on the weight of the intermediate polyester polyol of at least one polyol selected from the group consisting of ethylene glycol, diethylene glycol, propylene glycol, dipropylene glycol, neopental glycol, 1,4-butanediol, 1,6-hexanediol, glycerine, trimethylol propane and tetramethylene glycol;
(2) about 45% to about 77% based on the weight of the phthalate polyester-ether polyol of propylene oxide; and
(3) an effective amount of a double metal cyanide complex catalyst;
(C) from 0% to about 50% by weight of an auxiliary polyether polyol, polyester polyol, or a mixture thereof;
(D) from 0% to about 10% based on the weight of the composition of a blowing agent; and
(E) from 0% to about 5% based on the weight of the composition of a compatibilizing surfactant; and
(II) polymerizing the combination.

3. A composition suitable for preparing urethane prepolymers, urethane foams, or non-foam urethanes for use in coatings, adhesives, sealants or elastomers, comprising:
(A) from about 10% to about 60% based on the weight of the composition of an isocyanate;
(B) from about 23% to about 55% based on the weight of the composition of a phthalate polyester-ether polyol which is the reaction product of:
(1) an intermediate polyester polyol that is the reaction product of:
(i) about 42% to about 52% based on the weight of the polyester polyol of phthalic anhydride, phthalic acid or mixtures thereof; and
(ii) about 33% to about 58% based on the weight of the polyester polyol of at least one polyol selected from the group consisting of ethylene glycol, diethylene glycol, propylene glycol, dipropylene glycol, neopental glycol, 1,4-butanediol, 1,6-hexanediol, glycerine, trimethylol propane and tetramethylene glycol;
(2) about 45% to about 77% based on the weight of the phthalate polyester-ether polyol of propylene oxide; and
(3) an effective amount of a double metal cyanide complex catalyst;
(C) from 0% to about 50% based on the weight of the composition of an auxiliary polyether polyol, polyester polyol, or a mixture thereof;
(D) from 0% to about 10% based on the weight of the composition of a blowing agent; and
(E) from 0% to about 5% based on the weight of the composition of a compatibilizing surfactant.

4. A composition according to claim 3, wherein the isocyanate is 2,4-toluene diisocyanate, 2,4/2,6-toluene diisocyanate, diphenyl methane 4,4′-diisocyanate, hexamethylene diisocyanate, isophorone diisocyanate, or a mixture thereof.

5. A composition according to claim 3, wherein the phthalate polyester-ether polyol has the formula: 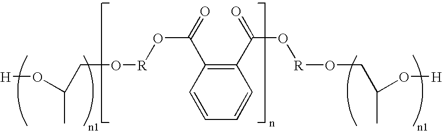
where each R is —(CH₂CH₂OCH₂CH₂)—; where each n1 is independently 1-200; and where n=1-200.

6. A composition according to claim 3, comprising from about 3% to about 40%, based on the weight of the composition, of the auxiliary polyether-based or polyester-based polyol, or a mixture thereof.

7. A composition according to claim 6, comprising from about 5% to about 35% based on the weight of the composition, of the auxiliary polyether-based or polyester-based polyol, or a mixture thereof.

8. A composition suitable for preparing urethane prepolymers, urethane foams, or non-foam urethanes for use in coatings, adhesives, sealants or elastomers, comprising:
(A) from about 10% to about 70% based on the weight of the composition of an isocyanate;
(B) from about 0.02% to about 5.0% based on the weight of the composition of a urethane catalyst;
(C) from about 23% to about 90% based on the weight of the composition of a phthalate polyester-ether polyol which is the reaction product of:
(1) an intermediate polyester polyol that is the reaction product of:
(i) about 42% to about 52% based on the weight of the intermediate polyester polyol of phthalic anhydride, phthalic acid or mixture thereof; and
(ii) about 33% to about 58% based on the weight of the intermediate polyester polyol of at least one polyol selected from the group consisting of ethylene glycol, diethylene glycol, propylene glycol, dipropylene glycol, neopental glycol, 1,4-butanediol, 1,6-hexanediol, glycerine, trimethylol propane and tetramethylene glycol;
(2) about 45% to about 77% based on the weight of the phthalate polyester-ether polyol of propylene oxide; and
(D) from 0% to about 50% based on the weight of the composition of an auxiliary polyether polyol, polyester polyol, or a mixture thereof;
(E) from 0% to about 10% based on the weight of the composition of a blowing agent; and
(F) from 0% to about 5% based on the weight of the composition of a compatibilizing surfactant.

9. A composition according to claim 8, wherein the isocyanate is 2,4-toluene diisocyanate, 2,4/2,6-toluene diisocyanate, diphenyl methane 4,4′-diisocyanate, hexamethylene diisocyanate. isophorone diisocyanate, or mixtures thereof.

10. A composition according to claim 9, wherein the urethane catalyst is tetramethylbutanediamine, 1,4-diaza(2,2,2)bicyclooctane, dibutyltindilaurate tinoctoate, dimorpholine diethylether, or mixtures thereof.

11. A composition according to claim 8, wherein the phthalate polyester-ether polyol has the formula: 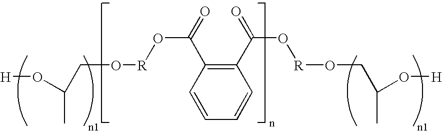
wherein each R is —(CH₂CH₂OCH₂CH₂)—; where each n1 is independently 1-200; and where n=1-200.

12. A composition according to claim 8, comprising from about 3% to about 40%, based on the weight of the polyester-ether polyol, of the auxiliary polyether-based or polyester-based polyol, or a mixture thereof.

13. A composition according to claim 12, comprising from about 5% to about 35%, based on the weight of the polyester-ether polyol, of the auxiliary polyether-based or polyester-based polyol, or a mixture thereof.

14. A method for preparing urethane prepolymers, urethane foams or non-foam urethanes for use in coatings, adhesives, sealants or elastomers, comprising:
(I) combining:
(A) from about 10% to about 60% based on the weight of the composition of an isocyanate;
(B) from about 0.02% to about 5.0% based on the weight of the composition of a urethane catalyst; and
(C) from about 23% to about 55% based on the weight of the composition of a phthalate polyester-ether polyol which is the reaction product of:
(1) an intermediate polyester polyol that is the reaction product of:
(i) about 42% to about 52% based on the weight of the intermediate polyester polyol of phthalic anhydride, phthalic acid or mixture thereof; and
(ii) about 33% to about 58% based on the weight of the intermediate polyester polyol of at least one polyol selected from the group consisting of ethylene glycol, diethylene glycol, propylene glycol, dipropylene glycol, neopental glycol, 1,4-butanediol, 1,6-hexanediol, glycerine, trimethylol propane and tetramethylene glycol;
(2) about 45% to about 77% based on the weight of phthalate polyester-ether polyol of propylene oxide; and
(3) an effective amount of a double metal cyanide complex catalyst;
(D) from 0% to about 50% based on the weight of the composition of an auxiliary polyether polyol, polyester polyol, or a mixture thereof;
(E) from 0% to about 10% based on the weight of the composition of a blowing agent;
(F) from 0% to about 5% based on the weight of the composition of a compatibilizing surfactant, to form a mixture; and
(II) reacting the mixture to form a urethane prepolymer, urethane foam or non-foam urethane coating, adhesive, sealant or elastomer.
